(19) United States
(12) Patent Application Publication
(10) Pub. No.: US 2014/0136607 A1
(43) Pub. Date: May 15, 2014

(54) METHOD AND SYSTEM FOR PERFORMING PARENT CONTROL ON MOBILE DEVICE

(71) Applicant: Beijing Netqin Technology Co., Ltd., Beijing (CN)

(72) Inventors: Jianhong Ou, Beijing (CN); Yanmin Chen, Beijing (CN); Shihong Zou, Beijing (CN); Yu Lin, Beijing (CN)

(21) Appl. No.: 14/129,765

(22) PCT Filed: Dec. 26, 2012
(86) PCT No.: PCT/CN2012/087523

§ 371 Date: Dec. 27, 2013

(30) Foreign Application Priority Data
Dec. 29, 2011 (CN) 201110452314.1

(51) Int. Cl. H04L 12/24

(52) U.S. Cl. CPC H04L 41/00
USPC 709/203

(57) ABSTRACT

The present disclosure provides a method and a system for applying parental control to a mobile device. The method comprises: monitoring and recording, by the client, one or more types of information of the mobile device on a website to be browsed by a first user, geographical location information, an installation event for an application and an initiation event of an application; uploading, by the client, to the server one or more of the following contents: the one or more types of recorded information, messages sent and received by the first user of the mobile device and a call record of the mobile device; and receiving, by the server, the uploaded contents and providing an interface for a second user to view the contents. The present disclosure is advantageous in that the operational behaviors of the user of the mobile device can be monitored in real time and the parents can monitor the operational behaviors of the user of the mobile device by accessing the data at the server.

### TECHNICAL FIELD

The present disclosure relates to communication security, and more particularly, to a method and system for applying parental control to a mobile device.

### BACKGROUND

With the development of the mobile communication industry, more and more users select mobile device as terminals for accessing the internet. It has become a prevalent trend to use mobile devices, such as mobile phones, to access the internet. However, there are a large amount of contents on the internet that are inappropriate or even harmful for minors to browse. Typically, mobile device terminals are incapable of providing effective support for protection of minors. Mobile devices cannot provide real-time content analysis or classification control due to their limited computation capabilities.

Some solutions have been proposed in the prior art. For example, Chinese Patent Application No. 201010173204.7, entitled “A Method for Function Control in Mobile Terminal”, filed on May 13, 2010, discloses a technique for parental control. This technique includes, after a user logs into a function control module: 1) setting a login password in a password management unit first; 2) selecting a function on/off control unit to display a list of all functions on a screen of a terminal; 3) setting an property of each function as “allowed” or “prohibited” and setting a period of time during which the function is “allowed” or “prohibited” to be used; and 4) setting correct time for a system. This technique enables parents to effectively control the time period during which their kids are allowed to use certain functions in the mobile terminals, thereby preventing them from wasting their time for study in using these functions. However, this technique is restricted in that it can only limit the time during which the minors use the mobile phones, but cannot control the contents they access on the internet via the mobile phones or the contents of programs they execute on the mobile phones. As the processing capabilities of the mobile devices gradually improve, their capabilities for processing data contents become close to those of personal computers. There have been dedicated mobile applications for playing videos, and even some mobile applications involving pornographic contents. Therefore, it is not possible to absolutely preventing minors from accessing harmful contents by simply limiting the time during which they use the mobile phones.

As discussed above, the existing solutions are limited in that they cannot monitor user operations and analyze contents accessed by the user in real time.

### SUMMARY

It is an object of the present disclosure to provide a method and system for applying parental control to a mobile device, capable of fully monitoring operations by a minor on the mobile device. With a “Client plus Cloud” solution, information contents received or accessed by the minor can be analyzed in real time and the operation by the minor can be restricted based on a restriction rule set by parents.

According to an aspect of the present disclosure, a method for applying parental control to a mobile device is provided. The method is performed by a client and a server and comprises: monitoring and recording, by the client, one or more types of information of the mobile device on a website to be browsed by a first user, geographical location information, an installation event for an application and an initiation event of an application; uploading, by the client, to the server one or more of the following contents: the one or more types of recorded information, messages sent and received by the first user of the mobile device and a call record of the mobile device; and receiving, by the server, the uploaded contents and providing an interface for a second user to view the contents.

In an embodiment, the method further comprises: providing, by the server, an interface for identity recognition, such that the second user can log in and access the server.

In an embodiment, the method further comprises: providing, by the server, a restriction rule option for the second user to set a restriction rule.

In an embodiment, the method further comprises: making, by the client, a determination on the website to be browsed by the first user based on a website black list and a website white list, and allowing the first user to browse the website when the website is included in the white list or prohibiting the first user from browsing the website when the website is included in the black list, wherein the website black list and the website white list are stored in a database at the client; and uploading the website to be browsed by the first user to the server when the website is included in neither of the website black list and the website white list.

In an embodiment, the method further comprises: identifying, by the server, a webpage content category corresponding to the website to be browsed by the first user as uploaded by the client; determining whether to allow or prohibit browsing of the webpage content category based on a restriction rule for webpage content set by the second user; and sending, by the server, the determination result to the mobile device, such that the client executes the determination result.

In an embodiment, the method further comprises: making, by the server, a determination on the website to be browsed by the first user based on a website black list and a website white list at the server, so as to obtain a determination result to allow browsing when the website is included in the white list or to prohibit browsing when the website is included in the black list, wherein the website black list and the website white list at the server are stored in a database at the server; and sending, by the server, the determination result to the mobile device, such that the client executes the determination result.

In an embodiment, the method further comprises: suspending, by the client upon monitoring an installation event of an application, the installation of the application and submitting information on the application to the server; determining, by the server, whether to allow the installation of the application based on a restriction rule set by the second user; and sending, by the server, the determination result to the client, such that the client executes the determination result.

In an embodiment, the method further comprises: making, by the client, a determination based on an application black list, an application white list and the information on the application to be installed, wherein the application black list and the application white list are stored in a database at the client; and allowing, by the client, the installation of the application when the application is included in the white list and suspending the installation of the application when the application is included in the black list.

In an embodiment, the method further comprises: suspending, by the client, the installation of the application and requesting entry of a password set by the second user when the application is included in the black list; and resuming the installation of the application when the entered password is consistent with the password set by the second user, or prohibiting the installation of the application otherwise.

In an embodiment, the method further comprises: submitting the information on the application to the server when the information on the application is included in neither of the black list and the white list at the client; determining, by the server, whether to allow the installation of the application based on a restriction rule set by the second user; and sending, by the server, the determination result to the client, such that the client executes the determination result.

In an embodiment, the method further comprises: suspending, by the client, the installation of the application and submitting the information on the application to the server when the application is included in the black list; receiving, by the server, the information on the application and requesting entry of a password for activating the installation; sending, by the server, an instruction to allow the installation to the client when the server receives a correct password; and resuming, by the client, the installation of the application.

In an embodiment, the information on the application comprises one or more of: a name of the application, a name of an installation package, an identification code for the application, time when the application is installed, and a hash value for the application.

In an embodiment, the method further comprises: suspending, by the client upon monitoring an initiation event of an application, the initiation of the application and submitting information on the application to the server; determining, by the server, whether to allow initiation of the application based on a restriction set by the second user; and sending, by the server, the determination result to the client, such that the client executes the determination result.

In an embodiment, the method further comprises: making, by the client, a determination based on a restriction set by the second user and the information on the application to be initiated; and allowing or prohibiting, by the client, the initiation of the application based on the determination result.

In an embodiment, the method further comprises: submitting the information on the application to the server when the information of the application is not included in a list of applications allowed or prohibited by the client; determining, by the server, whether to allow initiation of the application based on a restriction set by the second user; and sending, by the server, the determination result to the client, such that the client executes the determination result.

In an embodiment, the restriction set by the second user comprises a restriction on categories of application allowed to be initiated and/or a restriction on time during which applications of particular categories are allowed to be or prohibited from being initiated.

In an embodiment, the information on the application comprises one or more of: a name of the application, a name of an installation package, an identification code for the application, time when the application is installed, and a hash value for the application.

In an embodiment, the method further comprises: monitoring, by the client, information on a current geographical location of the mobile device in real time; determining, by the client, whether the current geographical location of the mobile device is out of a geographical location range set by the second user based on the geographical location range set by the second user; issuing, by the client, prompt information when it is determined that the current geographical location of the mobile device is out of the geographical location range set by the second user.

In an embodiment, the method further comprises: monitoring, by the client, a Short Message Service (SMS) message received by the mobile device in real time; and sending, by the client upon receiving a SMS message containing a particular content from a particular number, the information on the current geographical location of the mobile device to the particular number.

In an embodiment, the method further comprises: providing, by the server, an option for the second user to set a restricted geographical location range for the mobile device; sending, by the client, the information on the current geographical location of the mobile device to the server; and determining, by the server, whether the current geographical location of the mobile device is out of the restricted geographical location range.

In an embodiment, the method further comprises: returning, by the server upon determining that the current geographical location of the mobile device is out of the restricted geographical location range, the determination result to the client; and parsing, by the client, the determination result returned from the server and issuing a prompt to the first user, notifying that the geographical location is out of the restricted range.

In an embodiment, the method further comprises: returning, by the server upon determining that the current geographical location of the mobile device is out of the restricted geographical location range, the determination result to the client; and parsing, by the client, the determination result returned from the server and sending a prompt to a second mobile device specified by the second user.

In an embodiment, the method further comprises: providing, by the client, an option for the second user to select a category of website to be restricted from being browsed, a category of application to be restricted from being executed and a restricted geographical location.

In an embodiment, the option comprises categories to be restricted depending on different time periods of day.

In an embodiment, the option provided by the client comprises a restriction rule for a particular website as set by the second user.

According to another aspect of the present disclosure, a system for applying parental control to a mobile device is provided. The system comprises a client provided at the mobile device and a server provided at a server side. The client comprises a client communication module and at least one of a website monitoring module, an application installation monitoring module and a geographical location monitoring module. The server comprises a server communication module and at least one of a user setting module, a website analyzing module, an application analyzing module and a geographical location analyzing module. The client communication module is communicative with the server communication module and configured to send data to and receive data from the server. The server communication module is communicative with the client communication module and configured to send data to and receive data from the client. The website monitoring module is communicative with the mobile device and configured to monitor a website to be browsed by a user and submit the website to the client communication module. The application installation monitoring module is communicative with the mobile device and configured to monitor installation of an application and submit information on the application to the client communication module. The geographical location monitoring module is communicative with the mobile device and configured to monitor geographical location information of the mobile device in real time and submit the geographical location information to the client communication module. The user setting module provides a communication interface and is configured to receive selection of a restriction rule by a user. The website analyzing module is communicative with the user setting module and the server communication module and configured to determine whether to allow browsing of the website based on the restriction rule and submit the determination result to the server communication module. The application analyzing module is communicative with the user setting module and the server communication module and configured to determine whether to allow initiation of the application based on the restriction rule and submit the determination result to the server communication module. The geographical location analyzing module is communicative with the user setting module and the server communication module and configured to determine whether the mobile device is out of a restricted geographical range based on the restriction rule and submit the determination result to the server communication module.

The present disclosure is advantageous in that operations by a minor on the mobile device can be fully monitored.

The present disclosure is also advantageous in that, with the “Client plus Cloud” solution, information contents received or accessed by the minor can be analyzed in real time.

### BRIEF DESCRIPTION OF THE DRAWINGS

In the following, the present disclosure will be further detailed with reference to the figures, in which:

FIG. 1 is a flowchart illustrating a method for parental control according to the present disclosure;

FIG. 2 is a flowchart illustrating a method for parental control according to an embodiment of the present disclosure;

FIG. 3 is a flowchart illustrating a process for applying parental control to a website according to an embodiment of the present disclosure;

FIG. 4 is a flowchart illustrating a process for applying parental control to installation of an application according to an embodiment of the present disclosure;

FIG. 5 is a flowchart illustrating a process for applying parental control to a geographical location according to an embodiment of the present disclosure;

FIG. 6 is a flowchart illustrating a process for applying parental control to a geographical location according to an embodiment of the present disclosure;

FIG. 7 is a flowchart illustrating a process for applying parental control to a call record according to an embodiment of the present disclosure;

FIG. 8 is a schematic diagram of a mobile device to which parental control is applied according to an embodiment of the present disclosure;

FIG. 9 is a schematic diagram of a server for parental control according to an embodiment of the present disclosure;

FIG. 10 is a schematic diagram of a system for parental control according to an embodiment of the present disclosure; and

FIG. 11 is a flowchart illustrating a process for applying parental control to initiation of an application according to an embodiment of the present disclosure.

### DETAILED DESCRIPTION

The present disclosure provides a method and system for applying parental control to a mobile device, capable of fully monitoring operations by a minor on the mobile device. With the “Client plus Cloud” solution, information contents received or accessed by the minor can be analyzed in real time.

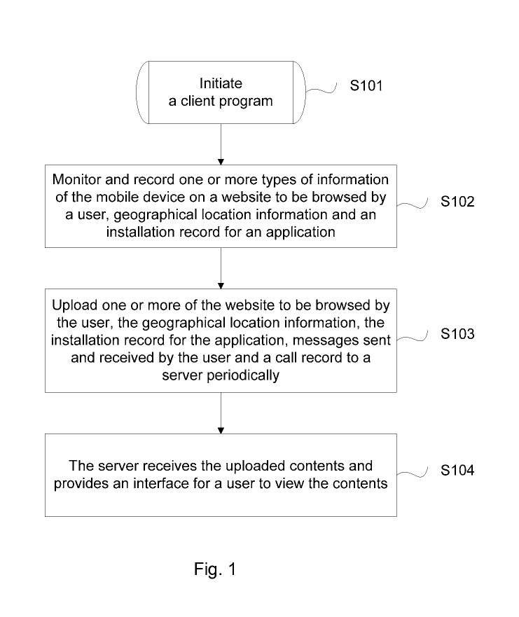

According to an embodiment of the present disclosure, a method for applying parental control to a mobile device is provided. The following descriptions will be given in connection with an environment of Android operating system platform, so as to explain in detail how client software operates to apply parental control to a mobile device in the Android system. As shown in the flowchart of FIG. 1, at step S101, a client program is initiated. At step S102, one or more types of information of the mobile device on a website to be browsed by a user, geographical location information and an installation record for an application are monitored and recorded. At step S103, one or more of the website to be browsed by the user, the geographical location information, the installation record for the application, messages sent and received by the user and a call record are uploaded to a server periodically. At step S104, the server receives the uploaded contents and provides an interface for a user to view the contents.

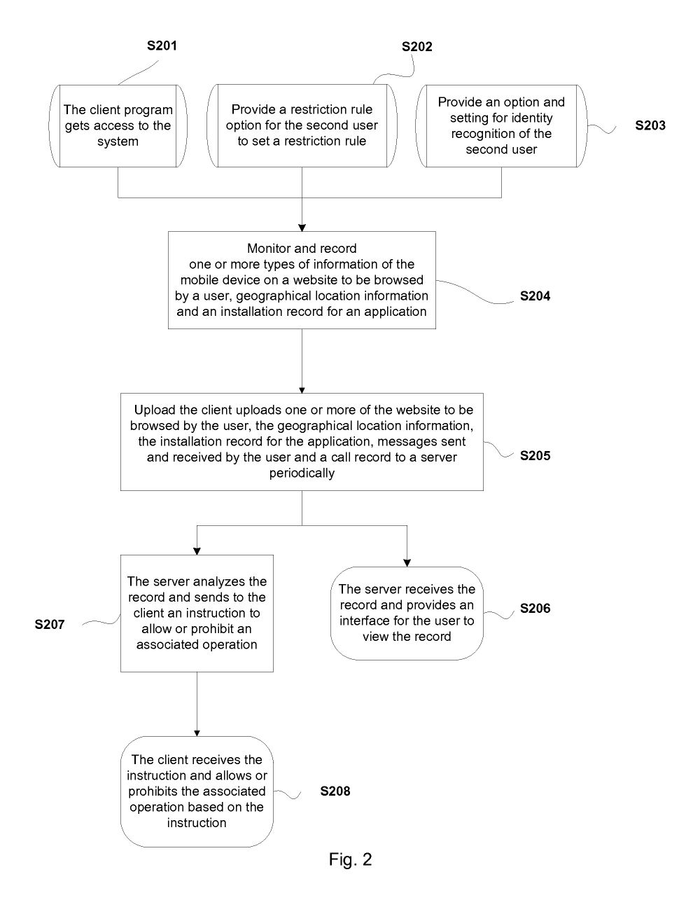

The flowchart of FIG. 2 explains in detail a process for applying parental control to a mobile device. At step S201, the client program gets access to the system. According to an embodiment of the present disclosure, in the Android operating system, the client program gets root access during the installation of the client program. During the installation of the client program, the user will be prompted to authorize an access right to the client program. In the present disclosure, the client needs to get an access right to deactivate other applications, e.g., the KILL_BACKGROUND_PROCESSES or RESTART_PACKAGES access right. Alternatively, in order to achieve the effect of the present disclosure, the client can for example request the user to authorize the above access right to the client upon its first initiation, or get the root access in the Android mobile operating system.

At step S202, a restriction rule option is provided for the second user to set a restriction rule. According to an embodiment of the present disclosure, the restriction rule is set by a second user (a parent) at the client and the server as appropriate. For example, the second user can select a restriction level (low, medium or high) via the client software, or log in and access a database at the server via an associated webpage and select a restriction level (low, medium or high) via the webpage. Each restriction level (low, medium or high) corresponds to a set of default restricted items. As an example, the low restriction level may correspond to a specific restriction that only browsing of pornographic web pages is prohibited, installation and use of applications are not restricted and geographical location is not restricted. According to an embodiment of the present disclosure, the specific restricted items can be defined by the second user. For example, the second user can select restricted items including any pornographic, violent and anti-government web pages; any game applications and a particular restricted range for geographical location. The restricted items may vary depending on time periods of day. For example, difference restricted items can be set for a morning time period and an entertainment time period at night.

At step S203, an option and setting for identity recognition of the second user is provided. According to an embodiment of the present disclosure, the second user can have an account valid at both the client and the server. The client software provides a mechanism for recognizing a username and a password for the second user. Also, the service provides a mechanism for recognizing a username and a password, such that the second user can log in his/her network account by entering the username and the password to access data (e.g., records for user of the mobile device by the first user and setting of the restriction rule by the second user) at the server via a webpage.

At step S204, one or more types of information of the mobile device on a website to be browsed by a user, geographical location information and an installation record for an application are monitored and recorded. In the Android operating system as an example, specific program information, such as information on a website requested by a web browser and an installation record of an application, can be read from a system log using the Logcat command. The geographical location information can be determined by obtaining an identification of the cell where the mobile phone is camping (Cell ID) or a location area code of a neighboring base station.

At step S205, the client uploads one or more of the website to be browsed by the user, the geographical location information, the installation record for the application, messages sent and received by the user and a call record are uploaded to a server periodically. According to an embodiment of the present disclosure, the uploading can be done using uplink transmission of GPRS or CDMA. Alternatively, the ASP technique can be used to write the website, the program name or the geographical location information plus a name of process at the server into a URL address and deliver it to the server for processing.

At step S206, the server receives the record and provides an interface for the user to view the record. The server receives the website, the program name or the geographical location information and stores the received information to the account associated with the second user such that the second user can login via a webpage to view the information.

At step S207, the server analyzes the record and sends to the client an instruction to allow or prohibit an associated operation. The server receives the website, the program name or the geographical location information and determines whether to allow browsing of the website, whether to allow installation of the application and whether the geographical location information is included in a geographical area restricted by the user, based on the restriction rule set by the second user. The determination result is returned to the client.

At step S208, the client receives the instruction and allows or prohibits the associated operation based on the instruction. Based on the determination result from the server, the client allows or prohibits (e.g., by automatically deactivating the web browser) the access to the website, allows or prohibits the initiation of the application and issues an alert to the first user when the geographical location of the mobile device is out of the geographical range restricted by the second user.

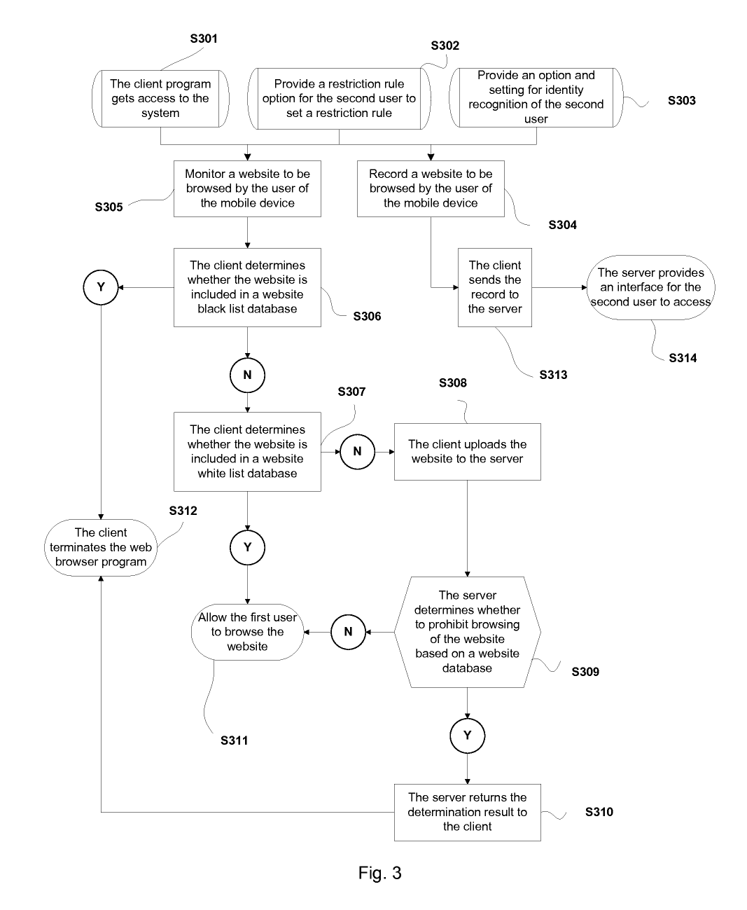

The flowchart of FIG. 3 explains in detail a process for applying parental control to a website to be browsed in a mobile device. At step S301, the client program gets access to the system. At step S302, a restriction rule option is provided for the second user to set a restriction rule. At step S303, an option and setting for identity recognition of the second user is provided.

At step S305, a website to be browsed by the user of the mobile device is monitored. In the Android operating system as an example, specific program information, such as information on a website requested by a web browser, can be read from a system log using the Logcat command. In particular, the client program obtains an action of an operation in the application, an action related data and an additional data (known as Intent in the Android system). For example, when the browser in the system makes a request to connect a website “http://m.netqin.com/products/av/?q=av&”, a corresponding description will be stored in the system log: 12-02 16:32:28.710: INFO/ActivityManager(1330): Starting activity: Intent {act=android.intentaction.VIEW cat=[android.intent.category.BROWSABLE] dat=http://m.netqin.com/products/av/?q=av&cmp=com.android.browser/.BrowserActivity} from pid 19738. The website to be browsed in the mobile device can be monitored by using the Logcat command to read the description of the request of the browser from the system log in real time.

At step S304, the description of the request of the browser is read from the system log in real time using the Logcat command and the information on the website is extracted and stored in a use record for the first user in the client.

At step S313, the client sends the record to the server. The client may send the website the browser requests to access to the server periodically (e.g., every day or every week) depending on a user preference setting. The record for the website the browser requests to access can be written into an XML file or another file format for uploading by the client.

At step S314, the server provides an interface for the second user to access. The website record uploaded in the step S313 further contains username or account information. Upon receiving the website record, the server stores the website record in a database based on the username or account information. The server provides an interface accessible by the user, such that the second user can log in the account and access the associated website record via a webpage.

At step S306, upon monitoring the website to be browsed by the user, the client determines whether the website is included in a website black list database. The website black list database is stored in the mobile device and includes a list of websites that the first user is prohibited from accessing. The categories of websites that the first user is prohibited from accessing can be selected, increased or decreased depending on the settings by the second user at the client or the server. The list of websites included in each website category can be updated periodically by communication with the server.

If the client determines that the website is included in the website black list database, the process proceeds with step S312 where the client terminates the web browser program. If the client determines that the website is not included in the website black list database, the process proceeds with step S307 where the client determines whether the website is included in a website white list database. The website white list database is stored in the mobile device and includes a list of websites that the first user is allowed to access. The categories of websites that the first user is allowed to access can be selected, increased or decreased depending on the settings by the second user at the client or the server. The list of websites included in each website category can be updated periodically by communication with the server.

If the client determines that the website is included in the website white list database, the process proceeds with step S311 where the first user is allowed to browse the website. If the client determines that the website is not included in the website white list database (i.e., the website is included in neither of the black list and the white list), then at step S308, the client uploads the website to the server.

At step S309, the server determines whether to prohibit browsing of the website based on a website database. According to an embodiment of the present disclosure, the website database is stored at the server, including website categories to which access is restricted. The user can select categories to which access is restricted and define rules for restriction depending on his/her preference. At step S310, the server returns the determination result to the client.

If the determination result from the server is to prohibit browsing of the website, then at step S312, the client terminates the web browser program.

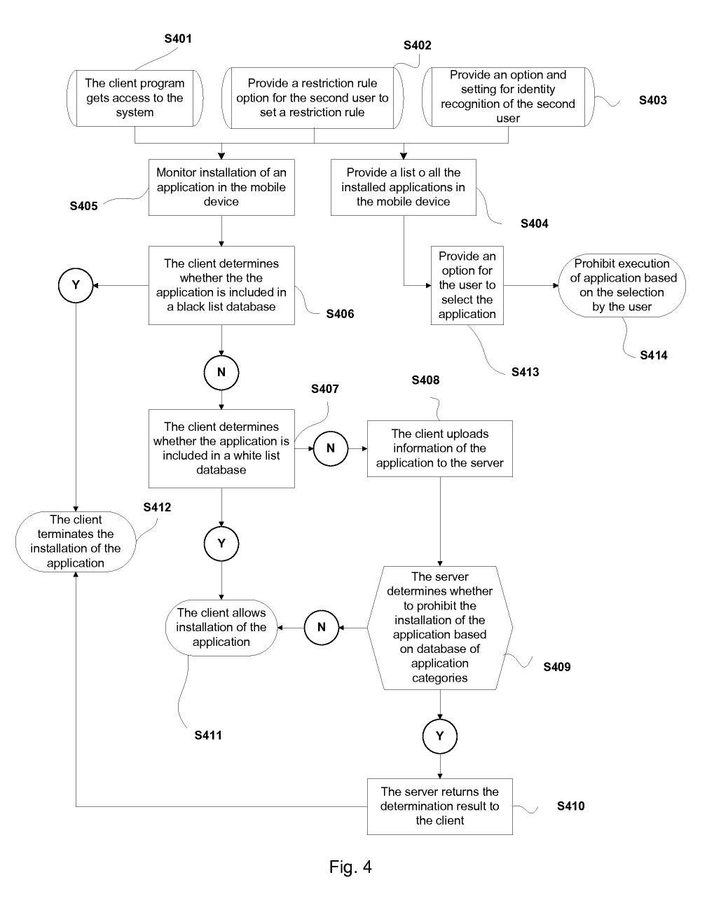

The flowchart of FIG. 4 explains in detail a process for applying parental control to an installed application in a mobile device. At step S401, the client program gets access to the system. At step S402, a restriction rule option is provided for the second user to set a restriction rule. At step S403, an option and setting for identity recognition of the second user is provided.

At step S405, installation of an application in the mobile device is monitored. In the Android operating system as an example, an installation record of an application can be read from a system log using the Logcat command. For example, for an application com.renren.mobile.android, the system log can be: 12-02 16:34:21.390: INFO/ActivityManager(1330): Starting activity: Intent {act=android.intentaction.MAIN cat=[android.intent.category.LAUNCHER] flg=0x10200000 cmp=com.renren.mobile.android/ui.WelcomeScreen bnds=[360,68][461,196]} from pid 14881. All the applications requested to be installed in the mobile device can be monitored by reading descriptions of the requests for installing the applications from the system log in real time using the Logcat command.

At step S404, a list of all the installed applications in the mobile device is provided. At step S413, the list of all the installed applications is presented to the second user and each application is provided with an option (e.g., a check box). At step S414, after the second user makes his/her selection, the client program prohibits execution of application based on the selection by the second user.

According to an embodiment of the present disclosure, at step S413, the client sends the list of all the installed applications to the server. The client may send the records for all the installed applications to the server periodically (e.g., every day or every week) depending on a user preference setting. The records for the applications can be written into an XML file or another file format for uploading by the client. The server provides an interface for the second user to access. The records for the applications uploaded in the step S413 further contain username or account information. Upon receiving the records for the applications, the server stores the records for the applications in a database based on the username or account information. The server provides an interface accessible by the user, such that the second user can log in the account and access the associated records for the applications via a webpage.

At step S406, upon monitoring an installation event of an application, the client determines whether the application is included in an application black list database. The application black list database is stored in the mobile device and includes a list of applications that are prohibited from being installed in the mobile device and prohibited categories. The categories of applications that are prohibited from being installed in the mobile device can be selected, increased or decreased depending on the settings by the second user at the client or the server. The list of applications included in each application category can be updated periodically by communication with the server.

If the client determines that the application is included in the black list database, the process proceeds with step S412 where the client suspends the installation of the application. The client can request entry of a password set by the second user. If the entered password is consistent with the password set by the second user, the installation of the application is resumed. Otherwise, the installation of the application is prohibited. If the client determines that the application is not included in the black list database, the process proceeds with step S407 where the client determines whether the application is included in a white list database. The application white list database is stored in the mobile device and includes categories of applications that are allowed to be installed in the mobile device and a list of applications that are allowed to be installed in the mobile device. The categories of applications that are allowed to be installed in the mobile device can be selected, increased or decreased depending on the settings by the second user at the client or the server. The list of applications included in each application category can be updated periodically by communication with the server. For example, the application black list may include violent application, pornographic applications and instant messaging applications. Typically, parents will prohibit minors from using any applications involving violence and pornography. Also, parents may, as desired, prohibit minors from using any instant messaging applications, in order to present the minors from wasting their time.

If the client determines that the application is included in the white list database, the process proceeds with step S411 where the installation of the application is allowed. If the client determines that the application is not included in the white list database (i.e., it is included in neither of the black lists and the white list), then at step S408, the client uploads information of the application to the server. The information on the application may include one or more of: a name of the application, a name of an installation package, an identification code for the application, time when the application is installed, and a hash value for the application. The hash value for the application can be calculated in accordance with Sha-1 or MD-5 algorithm. It can be appreciated by those skilled in the art that other equivalent algorithms for calculating a unique value for a file can also be used to achieve the same effect.

At step S409, the server determines whether to prohibit the installation of the application based on the information on the application. According to an embodiment of the present disclosure, a database of categorized applications is stored at the server. For each application, one or more of a name of the application, a name of an installation package, an identification code for the application, time when the application is installed, and a hash value for the application can be stored in a profile of the application. The user can select categories to which access is restricted and define rules for restriction depending on his/her preference. At step S410, the server returns the determination result to the client, such that the client can execute the determination result. According to an embodiment of the present disclosure, the second user may select to prohibit installation of an particular application, such as a game application, in order to prevent the minor from being addicted to it. If the determination result from the server is to prohibit the installation of the application, then at step S412, the client terminates the installation of the application.

According to an embodiment of the present disclosure, if the client determines that the application is included in the black list database in the step S406, the client will suspend the installation of the application and submit the information on the application to the server. The server then receives the information on the application and request entry of a password to activate the installation. When the server receives the correct password, it will send an instruction to allow the installation to the client, such that the client can resume the installation of the application.

According to an embodiment of the present disclosure, the process for applying parental control to the installed application in the mobile device as described above also applies to the control of initiation of an application. For example, the second user selects a category of application that is allowed to be initiated and the client in the mobile device monitors an application to be initiated in real time and allow or prohibit the initiation of the application based on the selection by the second user.

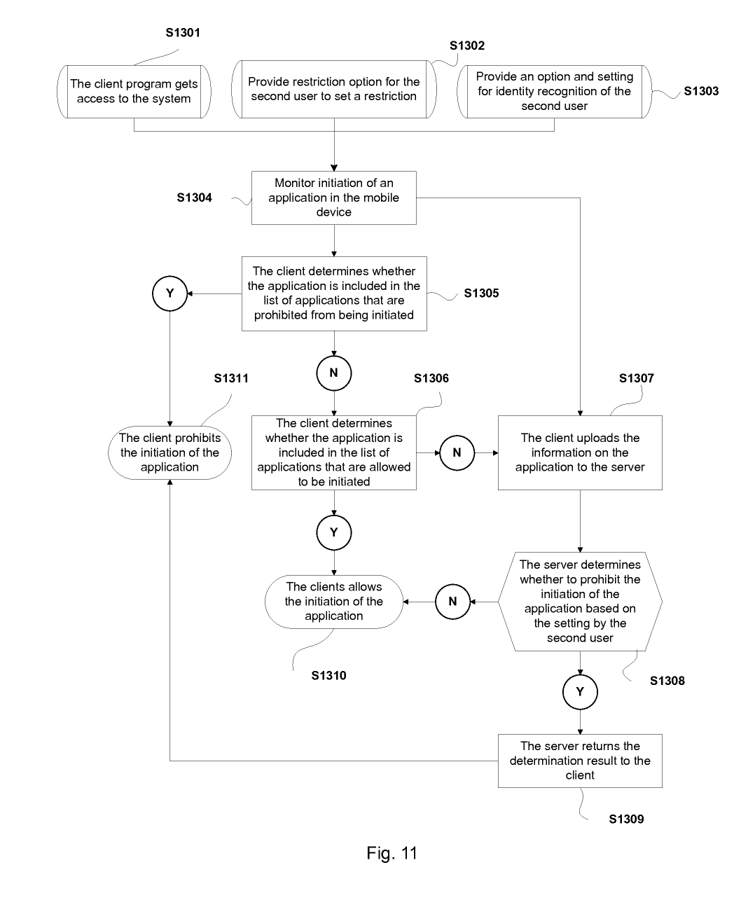

The flowchart of FIG. 11 explains in detail a process for applying parental control to initiation of an application in a mobile device. At step S1301, the client program gets access to the system. At step S1302, a restriction option is provided for the second user to set a restriction on initiation of application. For example, the second user can set a list of applications that are allowed to be initiated and a list of applications that are prohibited from being initiated, among the applications currently installed in the mobile device. The second user can set the list of applications that are allowed to be initiated and the list of applications that are prohibited from being initiated at the client or the server. Additionally, the second user can set a list of applications that are prohibited from being initiated during a particular period of time. For example, parents can configure to prohibit all the game applications in the mobile phone from being initiated in day time while allow them to be initiated at night, in order to prevent the study by a minor from being affected by any game application. At step S1303, an option and setting for identity recognition of the second user is provided.

At step S1304, initiation of an application in the mobile device is monitored. In the Android operating system as an example, the initiation of an application in the Android operating system needs to activate an associated activity. All the activities are controlled by ActivityManagerService. The procedure for activating an activity includes: 1) initiating a request startActivity(intent); 2) the Activity Service Manager receiving the request and executing an StartActivity fucntion; 3) app.thread.scheduleLaunchActvity(app,r)@ActivityThread.java; 4) creating a new ActivityRecord in the application APP; 5) creating a new Activity object and placing it into ActivityRecord; 6) adding ActivityRecord to mActivites@ActivityThread; and 7) initiating Activity.on Create(..), where on Create is on Create in the application XXXActivity. Here, an attachApplication function is called by a proxy and a transact mechanism in a binder kernel driving device is used to creating ProcessRecord information in ActivityManagerService. Thus, data can be read from a data reception buffer of the system driving device (the binder kernel driving device) for communication among system processes. Based on the intercepted data, the system service requested by ActivityManagerService can be replaced with a corresponding simulated system service. In this way, the initiation of the application can be suspended. The information on the application, such as UID of the application, can be learned by reading information from the intercepted data.

At step S1305, the client determines whether the application is included in the list of applications that are prohibited from being initiated. If the application is included in the list of applications that are prohibited from being initiated, then at step S1311, the client prohibits the initiation of the application. If the application is not included in the list of applications that are prohibited from being initiated, then at step S1306, the client determines whether the application is included in the list of applications that are allowed to be initiated. If the application is included in the list of applications that are allowed to be initiated, then at step S1310, the clients allows the initiation of the application. If the application is included in neither of the list of applications that are prohibited from being initiated and the list of applications that are allowed to be initiated, e.g., when the application may be installed after these lists have been set by the second user or when the application is installed in the mobile device by means of silent installation or otherwise like a virus, then at step S1307, the client uploads the information on the application to the server. At step S1308, the server determines whether to prohibit the initiation of the application based on the setting by the second user. At step S1309, the server returns the determination result to the client, such that the client can execute the determination result. The client operates based on the determination result to prohibit the initiation of the application at step S1311, or allow the initiation of the application at step S1310.

In the above embodiment, the steps for local determination at the client, such as the steps 1305 and 1306 in FIG. 11, can be omitted and the client can send the information on the application directly to the server for determination.

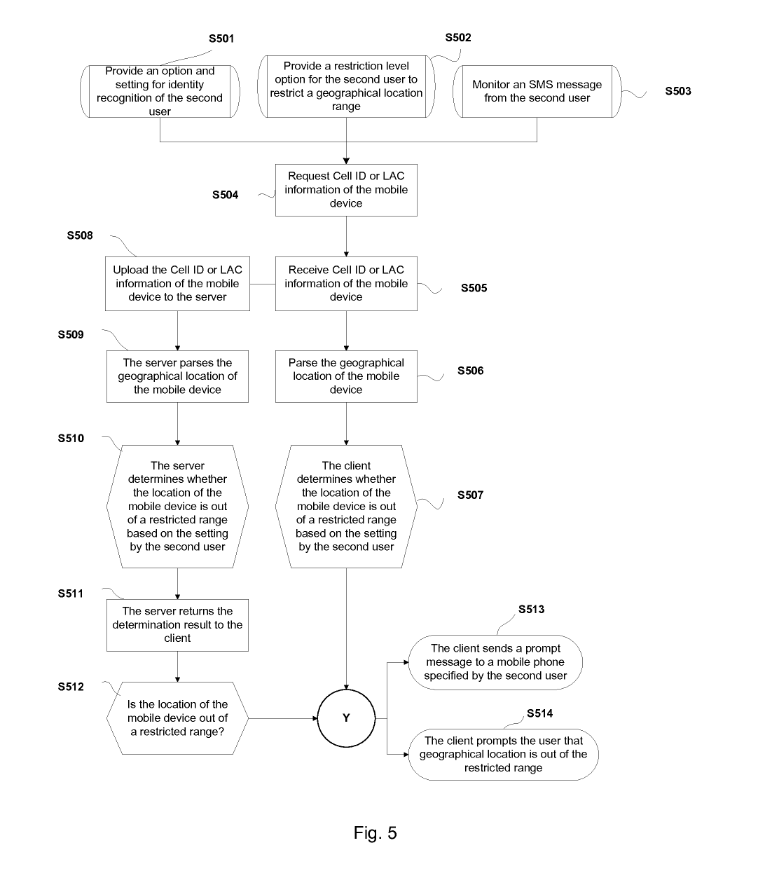

The flowchart of FIG. 5 explains in detail a process for applying parental control to location of a mobile device. At step S501, an option and setting for identity recognition of the second user is provided. At step S502, a restriction level option is provided for the second user to restrict a geographical location range. At step S503, an SMS message from the second user is monitored. According to an embodiment of the present disclosure, the option and setting for identity recognition of the second user can include setting of a mobile phone number of the second user.

At step S504, the client requests information on Cell ID or LAC of the mobile device. Here, the Cell ID is an identification code of the cell where the mobile device is camping and the LAC is the location area code of the mobile communication system. The information on Cell ID or LAC can be obtained selectively depending on whether the communication protocol for the mobile device is GSM or CDMA. The step of requesting may include sending a request SMS message containing a particular content to a number set by a telecommunication operator, which will automatically return the information on Cell ID or LAC in response to receipt of the request SMS message. According to an embodiment of the present disclosure, the mobile device can send a request message to the telecommunication operator on a regular basis, or in response to receipt of an SMS message containing a particular content from the second user. For example, the mobile device can send a request message to the telecommunication operator upon receiving an SMS message from the second user containing a content of “Get Location”.

At step S505, the client receives the information on Cell ID or LAC of the mobile device. At step S506, the geographical location of the mobile device is parsed. According to an embodiment of the present disclosure, the current location of the mobile device can be determined based on the LAC, the Cell ID and a geographical location map of base stations of the telecommunication operator. Also, the current location of the mobile device can be determined based on Cell IDs of three or more of its neighboring base stations and the geographical location map of base stations of the telecommunication operator. The geographical location information determined based on the Cell ID or LAC information can be longitude and latitude information of the mobile device or a location range centered at a certain geographical location (longitude, latitude=X, Y) and having a radius of m.

At step S507, the client determines whether the location of the mobile device is out of a restricted range based on the setting by the second user. The client stores the restriction on geographical location set by the second user. This restriction may indicate that the mobile device should not move out of, or move into, a location range centered at a certain geographical location (longitude, latitude=a, b) and having a radius of r. The client compares the geographical location range of the mobile device and the restricted range set by the second user. If there is an intersection between these two ranges, it is determined that the mobile device is out of the geographical location range.

If the client determines that the mobile device is out of the restricted range, according to an embodiment of the present disclosure, at step S513, the client sends a prompt message to a mobile phone specified by the second user, e.g., to notify the second user in the form of SMS message. At step S514, the client prompts the first user, notifying him/her that his/her geographical location is out of the restricted range.

According to an embodiment of the present disclosure, at step S508, the client uploads the Cell ID or LAC information of the mobile device to the server. According to an embodiment of the present disclosure, the uploading can be done using uplink transmission of GPRS or CDMA. Alternatively, the ASP technique can be used to write the website, the program name or the geographical location information plus a name of process at the server into a URL address and deliver it to the server for processing.

At step S509, the server parses the geographical location of the mobile device. According to an embodiment of the present disclosure, the current location of the mobile device can be determined based on the LAC, the Cell ID and a geographical location map of base stations of the telecommunication operator. Also, the current location of the mobile device can be determined based on Cell IDs of three or more of its neighboring base stations and the geographical location map of base stations of the telecommunication operator. The geographical location information determined based on the Cell ID or LAC information can be longitude and latitude information of the mobile device or a location range centered at a certain geographical location (longitude, latitude=X, Y) and having a radius of m.

At step S510, the server determines whether the location of the mobile device is out of a restricted range based on the setting by the second user. The server stores the restriction on geographical location set by the second user. This restriction may indicate that the mobile device should not move out of, or move into, a location range centered at a certain geographical location (longitude, latitude=a, b) and having a radius of r. The server compares the geographical location range of the mobile device and the restricted range set by the second user. If there is an intersection between these two ranges, it is determined that the mobile device is out of the geographical location range.

At step S511, the server returns the determination result to the client. At step S512, the client parses the determination result returned from the server. If the determination result indicates that the location of the mobile device is out of the restricted range, the process proceeds with step S513 or S514.

According to an embodiment of the present disclosure, in the above steps S504, S505 and S508, the geographical location information of the mobile device can alternatively be determined using GPS technique.

According to an embodiment of the present disclosure, in the above step S513, the prompt that the geographical location is out of the restricted range can be sent to a second mobile device specified by the second user in a different way. For example, client software can be installed in the second mobile device and connected to a network element which sends the prompt information to the client installed in the second mobile device in real time via a TCP/IP connection.

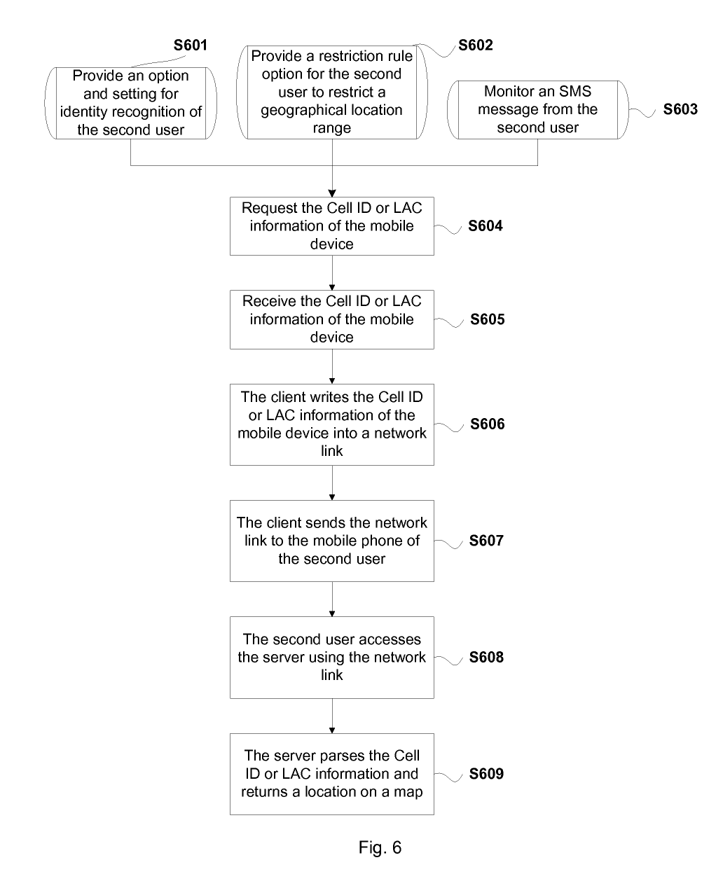

The flowchart of FIG. 6 explains in detail a process for applying parental control to location of a mobile device. The process in which the client in the mobile device parses the Cell ID or LAC information and searches a map for the restricted range consumes some system resources. No matter whether the process is executed in the mobile device of the first user or the mobile device of the second user, the mobile device needs to be provided with a location map of a number of base stations of the telecommunication operator. Further, as the devices of the telecommunication operator upgrades, the map needs to be continuously updated to maintain its accuracy. Thus, the resources at the mobile device can be saved if the geographical location is parsed and compared with the restricted range at the server. Additionally, if the second user needs the current location of the first user to be displayed on a map, the client for the second user needs to store a huge amount of map data; whereas the server can easily mark the location and send the area of interest on the map to the second user in a picture form. According to an embodiment of the present disclosure, at step S601, an option and setting for identity recognition of the second user is provided. At step S602, a restriction rule option is provided for the second user to restrict a geographical location range. At step S603, an SMS message from the second user is monitored. According to an embodiment of the present disclosure, the option and setting for identity recognition of the second user can include setting of a mobile phone number of the second user.

Upon receiving an SMS message from the second user that requests for the location of the mobile device, at step S604, the client in the mobile device requests the Cell ID or LAC information of the mobile device from the telecommunication operator. The step of requesting may include sending a request SMS message containing a particular content to a number set by a telecommunication operator, which will automatically return the Cell ID or LAC information in response to receipt of the request SMS message.

At step S605, the Cell ID or LAC information of the mobile device is received. At step S606, the client writes the Cell ID or LAC information of the mobile device into a network link, e.g., http://www.netqin.com/protal/location.asp?MCC=460&MNC=00&LAC=657&CELLID=47 132.

At step S607, the client sends the network link to the mobile phone of the second user. At step S608, the second user accesses the server using the network link. At step S609, the server parses the Cell ID or LAC information and returns a location on a map. According to an embodiment of the present disclosure, the server receives the Cell ID or LAC information, “MCC=460&MNC=00&LAC=657&CELLID=47132”, parses the geographical location where the mobile device is located, marks the geographical location on the map, and returns an area on the map where the location is marked to the mobile phone of the second user in a picture form.

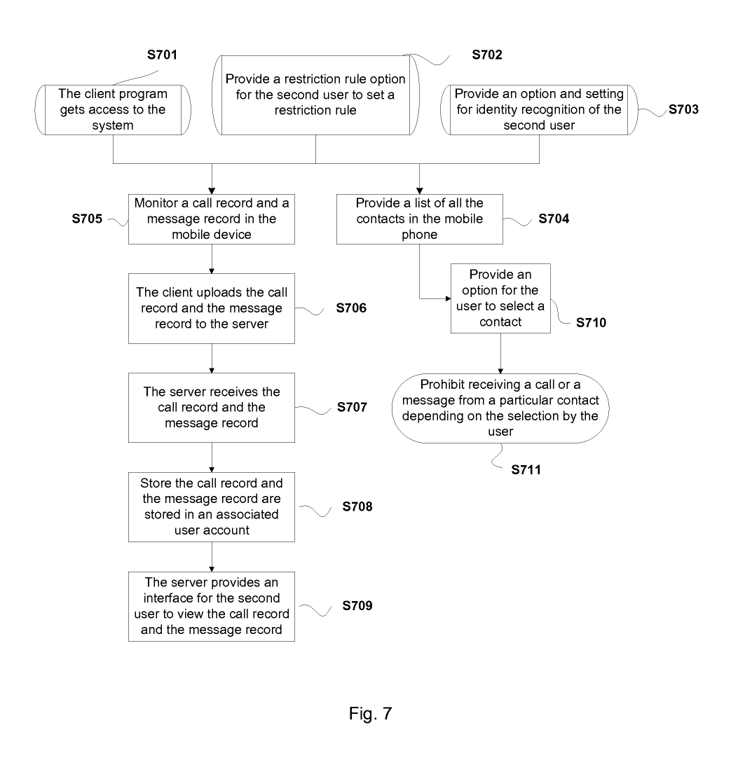

The flowchart of FIG. 7 explains in detail a process for applying parental control to a call record and a message in a mobile device. At step S701, an option and setting for identity recognition of the second user is provided. At step S702, a restriction rule option is provided for the second user to set a restriction rule, e.g., to prohibit calling or sending SMS message to any number other than those of contacts. At step S703, an SMS message from the second user is monitored. According to an embodiment of the present disclosure, the option and setting for identity recognition of the second user can include setting of a mobile phone number of the second user.

At step S704, a list of all the contacts in the mobile phone is provided. At step S710, an option is provided for the user to select a contact. For example, the second user can access the list of all the contacts currently in the mobile device. For each contact, the client may apply restriction on receiving a call from the contact, placing a call to the contact, receiving a message from the contact or sending a message to the contact. At step S711, depending on the selection by the user, the client prohibits receiving a call or a message from a particular contact. For example, after getting access to the system, the client program can monitor the telephone number of an incoming call or SMS message and check the telephone number against the restriction rule. If there is a restriction on the telephone number in the restriction rule, the client program automatically terminates the call or deletes the received SMS message.

According to an embodiment of the present disclosure, at step S705, the client program in the mobile device monitors a call record and a message record in the mobile device. When the client program gets access to the system of the mobile device, these records can be read in real time from specific addresses in a memory of the mobile device. At step S706, the client uploads the call record and the message record to the server, by means of TCP/IP uplink communication or the like. The uploaded contents can be included in an XML file or a file of another type.

At step S707, the server receives the call record and the message record. At step S708, the call record and the message record are stored in an associated user account. At step S709, the server provides an interface for the second user to view the call record and the message record.

According to an embodiment of the present disclosure, a method for applying parental control to a mobile device includes monitoring and controlling the mobile device with respect to one or more of a website to be browsed, installation of an application, execution of an application, a geographical location, a call record and a message record.

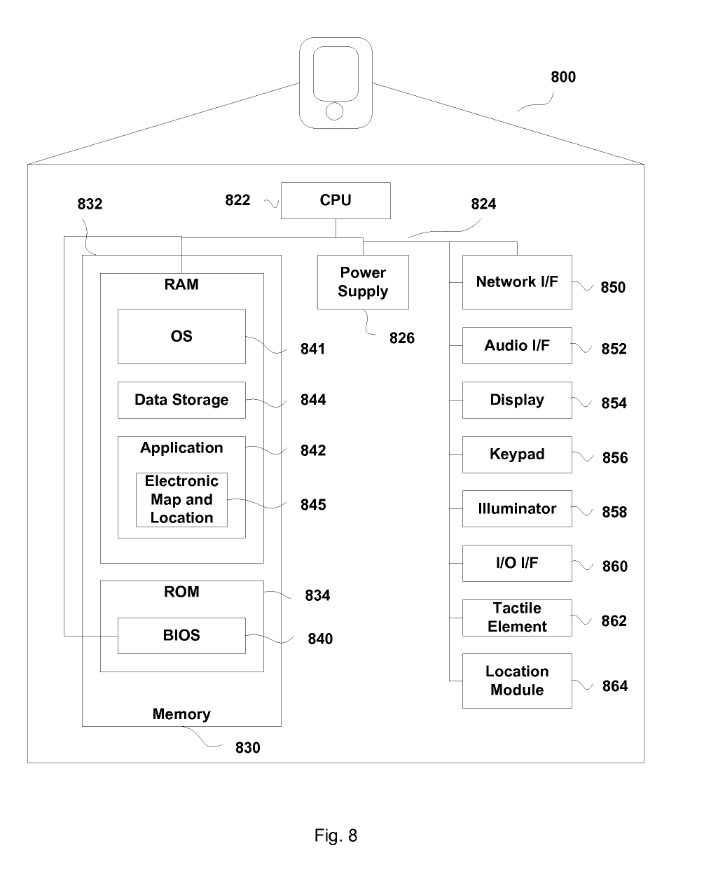

FIG. 8 shows elementary components of a mobile device to which the method of the present disclosure can be applied. The mobile device 800 includes a central processing unit (CPU) 822 in communication with a memory 830 via a bus 824. The mobile device 800 also includes a power supply module 826, one or more network interfaces 850, an audio interface 852, a display 854, a keypad 856, an illuminator 858, an input/output interface 860, a tactile element 862, and a location module 864. The power supply module 826 supplies power to the entire mobile device 800 and may include one or more rechargeable batteries. The power may also be supplied by an external power source, such as an AC adapter.

The mobile device 800 may communicate with a base station (not shown), or directly with another computer device. The network interface 850 may include circuitry for coupling the mobile device 800 to other networks and is constructed for use with one or more communication protocols including, but not limited to, global system for mobile communication (GSM), code division multiple access (CDMA), time division multiple access (TDMA), user datagram protocol (UDP), transmission control protocol/Internet protocol (TCP/IP), short message service (SMS), general packet radio service (GPRS), wireless application protocol (WAP), ultra wide band (UWB), IEEE 802.16 Worldwide Interoperability for Microwave Access (WiMax) or similar wireless communication protocols. The network interface 850 is sometimes known as a transceiver, transceiving device, or network adapter.

The audio interface 852 is arranged to produce and receive audio signals. For example, the audio interface 852 may be coupled to a speaker and a microphone to enable communication with others and/or voice recognition. The display 854 may be a liquid crystal display (LCD), gas plasma, light emitting diode (LED), or any other type of display used with a computing device. The display 854 may also include a touch sensitive screen arranged to receive touch input.

The keypad 856 may comprise any input device arranged to receive input from a user. For example, the keypad 856 may include numeric keys and special functional keys for selecting and sending images. The illuminator 858 includes a status indicator and provides light illumination. The illuminator 858 may remain active for a period of time in response to a particular event. For example, when the illuminator 558 is active, it can provide backlight for keys of the keypad 856 and stay on for a while. Also, the illuminator 858 may also position light sources on a translucent case to illuminate in response to a certain event.

The mobile device 800 also comprises an input/output interface 860 for communicating with external devices, such as a headset, or other input or output devices shown in FIG. 8. The input/output interface 860 can utilize one or more communication techniques, such as USB, infrared or Bluetooth. The tactile element 862 is arranged to provide tactile feedback to a user. For example, the tactile element 862 can vibrate the mobile device 800 when the mobile device 800 receives a call from another device.

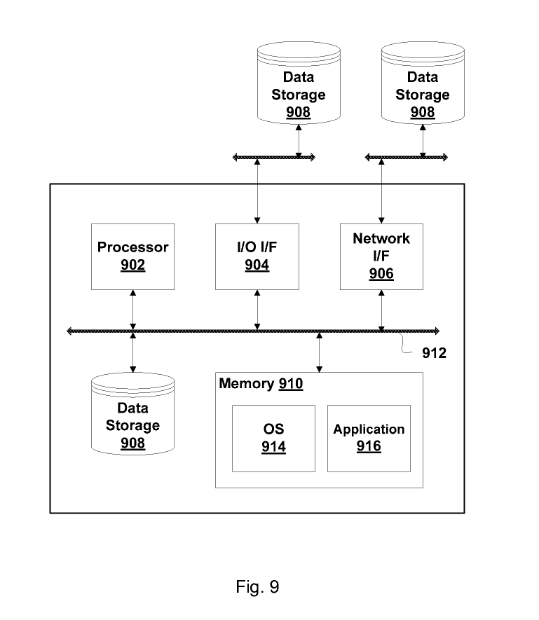

FIG. 9 shows elementary components of a server for implementing the method of the present disclosure. The server 900 may be a computer that includes a processor 902, an input/output (I/O) interface 904, a network interface 906, a data storage 908 and a memory 910. It can be appreciated by those of ordinary skill in the art that FIG. 9 depicts the server 600 in an simplified architecture and in practice the server 900 may include additional components and other structures to support conventional server operations. The components (902, 904, 906, 908, and 910) are communicatively coupled via a local interface 912. The local interface 912 may be for example one or more buses or other wired or wireless connections. The local interface 912 may have additional elements, which are omitted in FIG. 9 for simplicity, such as controllers, buffers, drivers, repeaters and receivers, among many others, to enable communications. Further, the local interface 912 may include address, control or data connections to enable appropriate communications among the aforementioned components.

The processor 902 is a hardware device for executing software instructions. The processor 902 may be a customized or commercially available processor, such as a central processing unit (CPU), a multi-processor architecture or any microprocessor chip capable of executing software instructions. When the server 900 is in operation, the processor 902 is configured to execute software instructions stored within the memory 910, retrieve data from the memory 910, and to generally control the server 900 pursuant to the software instructions. The I/O interface 904 may be used to receive user input and provide system output to one or more devices or components. The user input may be provided via a keyboard, a touch pad or a mouse. The system output may be provided via a display device and a printer. The I/O interface 904 can include for example a serial port, a parallel port, a small computer system interface (SCSI), an infrared (IR) interface, a radio frequency (RF) interface, and/or a universal serial bus (USB) interface.

The network interface 906 may be used to enable the server 900 to communicate with a network, such as the Internet. The network interface 906 may include, for example, an network card or a network adapter (e.g., an adapter for network traffic ranging from 10M to 10G) or a wireless local area network (WLAN) card or adapter. The network interface 906 may include address, control or data communications to enable network connection. The data storage 908 may be used to store data. The data storage 908 may include a volatile memory (e.g., a random access memory (RAM), such as dynamic RAM, static access memory, synchronous dynamic RAM and the like)), a non-static access memory (e.g., a Read Only Memory, a hard drive, a tape and a CD-ROM), or any combination thereof. Moreover, the data storage 908 may incorporate electronic, magnetic, optical, and/or other types of storage mediums. In one example, the data storage 908 may be located inside the server 900 such as, for example, an internal hard drive connected to the local interface 912 within the server 900. Additionally in another embodiment of the present disclosure, the data storage 908 may be located external to the server 900 such as, for example, an external hard drive connected to the server 900 via the I/O interface 904 (e.g., a SCSI or USB interface). In a further embodiment of the present disclosure, the data storage 908 may be connected to the server 900 through a network, for example, a network file server.

The memory 910 may include a volatile memory (e.g., a random access memory (RAM), such as dynamic RAM, static access memory, synchronous dynamic RAM and the like)), a non-static access memory (e.g., a Read Only Memory, a hard drive, a tape and a CD-ROM), or any combination thereof. Moreover, the data storage 908 may incorporate electronic, magnetic, optical, and/or other types of storage mediums. The memory 910 may have a distributed architecture, where various components are situated remotely from one another, but is accessible by each other via the processor 902. The software in the memory 910 may include one or more software programs, each of which includes a list of executable instructions for implementing logical functions. The software in the memory 910 further includes an operating system (O/S) 914 and one or more programs 916. The operating system 914 mainly controls the execution of the software programs, such as the software programs 916, and provides input/output control, file and data management, memory management and communication management and scheduling. The operating system 914 may be Windows NT, Windows 2000, Windows XP, Windows Vista, Windows 7, Windows Server 2003/2008, Solaris, LINUX, Android operating system or the like. The application programs 916 may be configured to implement various processes, algorithms, methods, and techniques described herein.

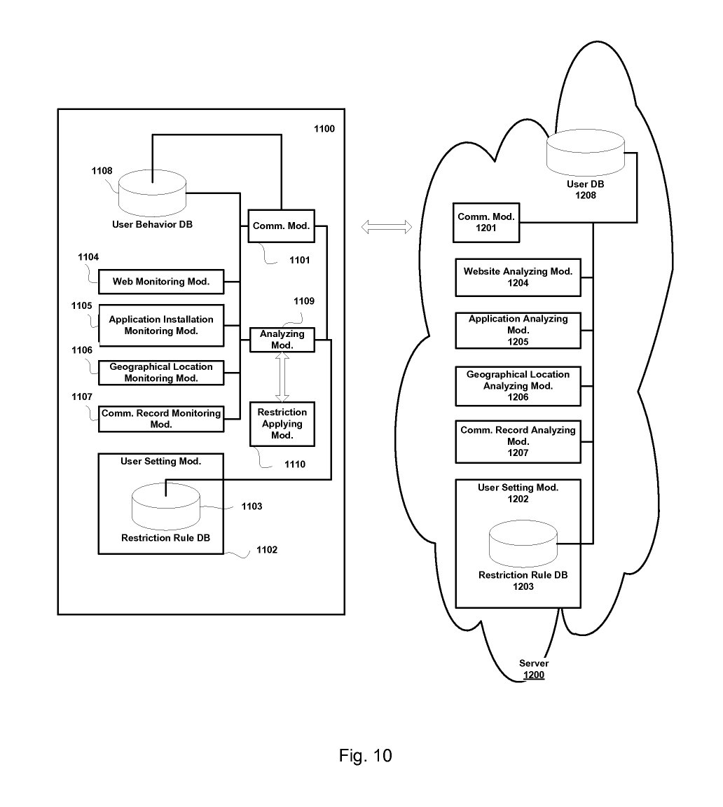

FIG. 10 shows a system for applying parental control to a mobile device according to an embodiment of the present disclosure. The system comprises a client 1100 provided at the mobile device and a server 1200 provided at a server side.

The client 1100 comprises a client communication module 1101, a website monitoring module 1104, an application installation monitoring module 1105, a geographical location monitoring module 1106, a user setting module 1102, a restriction rule database 1103, an analyzing module 1109 and a restriction applying module 1110.

The server 1200 comprises a server communication module 1201, a user setting module 1202, a website analyzing module 1204, an application analyzing module 1205, a geographical location analyzing module 1206, a communication record analyzing module 1207 and a user database 1208.

The client communication module 1101 is communicative with the server communication module 1201 and configured to send data to and receive data from the server. The client communication module 1101 can use a network interface of the mobile device to send and receive data wirelessly. The server communication module 1201 is communicative with the client communication module 1101 and configured to send data to and receive data from the client.

The website monitoring module 1104 is communicative with the operating system of the mobile device and configured to monitor a website to be browsed by a user and submit the website to the client communication module 1101 or to the client analyzing module 1109.

The application installation monitoring module 1105 is communicative with the operating system of the mobile device and configured to monitor installation of an application and submit information on the application to the client communication module 1101 or to the client analyzing module 1109.

The geographical location monitoring module 1106 is communicative with the mobile device and configured to monitor geographical location information of the mobile device in real time and submit the geographical location information to the client communication module 1101 or to the client analyzing module 1109.

The user setting module 1102 is configured to receive selection of a restriction rule by the user and store the user setting in the restriction rule database 1103. The restriction rule database 1103 stores data on website categories, application categories or restricted ranges of geographical locations, and marks restricted categories based on the user setting. The restriction rule database 1103 can be synchronized with the server via the communication module 1101, so as to update the data on the respective categories.

The communication record monitoring module 1107 is communicative with the operating system of the mobile device and configured to obtain a call record and an SMS message record of the mobile device in real time or periodically.

The analyzing module 1109 is communicative with the website monitoring module 1104, the application installation monitoring module 1105, the geographical location monitoring module 1106 and the communication record monitoring module 1107, and is configured to read the restriction rule from the user setting module. The analyzing module 1109 generates an analysis result based on the restriction rule and sends the result to the restriction applying module 1110. The restriction applying module 1110 applying an associated restriction to an operation of the mobile device based on the analysis result, e.g., to deactivate a web browser program, terminate installation of a program or send to the user a prompt that the location is out of the restricted range.

The website analyzing module 1204 is communicative with the user setting module 1202 and the server communication module 1201 and configured to determine whether to allow browsing of the website based on the restriction rule and submit the determination result to the server communication module 1201.

The application analyzing module 1205 is communicative with the user setting module 1202 and the server communication module 1201 and configured to determine whether to allow initiation of the application based on the restriction rule and submit the determination result to the server communication module 1201.

The geographical location analyzing module 1206 is communicative with the user setting module 1202 and the server communication module 1201 and configured to determine whether the mobile device is out of a restricted geographical range based on the restriction rule and submit the determination result to the server communication module 1201.

The above determination result obtained at the server 1200 is sent to the client 1100 via the server communication module 1201. Upon receiving the determination result, the client communication module 1101 sends it to the applying module 1110 to execute the determination result.

The user setting module 1202 provides a communication interface for the second user to log in and access the server to set a restriction rule. The user setting module 1202 includes a restriction rule database 1203. The restriction rule database 1203 stores data on website categories, application categories or restricted ranges of geographical locations, and marks restricted categories based on the user setting. The restriction rule database can also provide a personalized restriction rule. For example, the second user can prohibit accessing to a particular website or prohibit installation of a particular application.

The user database 1208 is communicative with the communication module 1201 and the user setting module 1202. The user database 1208 stores behavior records of the user of the mobile device, e.g., a web link the user requests to access, information on an application the user requests to install or a trajectory of geographical locations the user has visited. The second user can set a login account name and password using the user setting module and restrict the access to the user database 1208 by means of user identity recognition. The user database 1208 can receive the records of the use behavior of the user and the geographical location information from the mobile device in real time or periodically and stores them in a corresponding category in the account of the second user.

The present disclosure has been described with reference to the above apparatus and method. However, the apparatus and method described above are not an exhausted list of all possible combinations. It can be appreciated by those skilled in the art that further combinations and modifications can be made to the present disclosure. Therefore the present disclosure intends to cover all such modifications, alternations and variants. For example, the present disclosure is not limited to the determination by the server alone. Other forms of requests, e.g., first the client makes a determination and then the server makes a determination, can also achieve the monitoring purpose according to the method of the present disclosure. Further, while a particular feature of the present disclosure may have been disclosed in connection with one of the embodiments, it is possible that the feature can be combined with other features described in other embodiments.

1. A method for applying parental control to a mobile device, performed by a client and a server, comprising:
monitoring and recording, by the client, one or more types of information of the mobile device on a website to be browsed by a first user, geographical location information, an installation event for an application and an initiation event of an application;
uploading, by the client, to the server one or more of the following contents: the one or more types of recorded information, messages sent and received by the first user of the mobile device and a call record of the mobile device; and
receiving, by the server, the uploaded contents and providing an interface for a second user to view the contents.

2. The method of claim 1, further comprising:
providing, by the server, an interface for identity recognition, such that the second user can log in and access the server.

3. The method of claim 1, further comprising:
providing, by the server, a restriction rule option for the second user to set a restriction rule.

4. The method of claim 1, further comprising:
making, by the client, a determination on the website to be browsed by the first user based on a website black list and a website white list, and allowing the first user to browse the website when the website is included in the white list or prohibiting the first user from browsing the website when the website is included in the black list, wherein the website black list and the website white list are stored in a database at the client; and
uploading the website to be browsed by the first user to the server when the website is included in neither of the website black list and the website white list.

5. The method of claim 4, further comprising:
identifying, by the server, a webpage content category corresponding to the website to be browsed by the first user as uploaded by the client;
determining whether to allow or prohibit browsing of the webpage content category based on a restriction rule for webpage content set by the second user; and
sending, by the server, the determination result to the mobile device, such that the client executes the determination result.

6. The method of claim 4, further comprising:
making, by the server, a determination on the website to be browsed by the first user based on a website black list and a website white list at the server, so as to obtain a determination result to allow browsing when the website is included in the white list or to prohibit browsing when the website is included in the black list, wherein the website black list and the website white list at the server are stored in a database at the server; and
sending, by the server, the determination result to the mobile device, such that the client executes the determination result.

7. The method of claim 1, further comprising:
suspending, by the client upon monitoring an installation event of an application, the installation of the application and submitting information on the application to the server;
determining, by the server, whether to allow the installation of the application based on a restriction rule set by the second user; and
sending, by the server, the determination result to the client, such that the client executes the determination result.

8. The method of claim 1, further comprising:
making, by the client, a determination based on an application black list, an application white list and the information on the application to be installed, wherein the application black list and the application white list are stored in a database at the client; and
allowing, by the client, the installation of the application when the application is included in the white list and suspending the installation of the application when the application is included in the black list.

9. The method of claim 1, further comprising:
suspending, by the client, the installation of the application and requesting entry of a password set by the second user when the application is included in the black list; and
resuming the installation of the application when the entered password is consistent with the password set by the second user, or prohibiting the installation of the application otherwise.

10. The method of claim 8, further comprising:
submitting the information on the application to the server when the information on the application is included in neither of the black list and the white list at the client;
determining, by the server, whether to allow the installation of the application based on a restriction rule set by the second user; and
sending, by the server, the determination result to the client, such that the client executes the determination result.

11. The method of claim 8, further comprising:
suspending, by the client, the installation of the application and submitting the information on the application to the server when the application is included in the black list;
receiving, by the server, the information on the application and requesting entry of a password for activating the installation;
sending, by the server, an instruction to allow the installation to the client when the server receives a correct password; and
resuming, by the client, the installation of the application.

12. The method of claim 7, wherein the information on the application comprises one or more of: a name of the application, a name of an installation package, an identification code for the application, time when the application is installed, and a hash value for the application.

13. The method of claim 1, further comprising:
suspending, by the client upon monitoring an initiation event of an application, the initiation of the application and submitting information on the application to the server;
determining, by the server, whether to allow initiation of the application based on a restriction set by the second user; and
sending, by the server, the determination result to the client, such that the client executes the determination result.

14. The method of claim 1, further comprising:
making, by the client, a determination based on a restriction set by the second user and the information on the application to be initiated; and
allowing or prohibiting, by the client, the initiation of the application based on the determination result.

15. The method of claim 14, further comprising:
submitting the information on the application to the server when the information of the application is not included in a list of applications allowed or prohibited by the client;
determining, by the server, whether to allow initiation of the application based on a restriction set by the second user; and
sending, by the server, the determination result to the client, such that the client executes the determination result.

16. The method of claim 13, wherein the restriction set by the second user comprises a restriction on categories of application allowed to be initiated and/or a restriction on time during which applications of particular categories are allowed to be or prohibited from being initiated.

17. The method of claim 13, wherein the information on the application comprises one or more of: a name of the application, a name of an installation package, an identification code for the application, time when the application is installed, and a hash value for the application.

18. The method of claim 1, further comprising:
monitoring, by the client, information on a current geographical location of the mobile device in real time;
determining, by the client, whether the current geographical location of the mobile device is out of a geographical location range set by the second user based on the geographical location range set by the second user;
issuing, by the client, prompt information when it is determined that the current geographical location of the mobile device is out of the geographical location range set by the second user.

19. The method of claim 18, further comprising:
monitoring, by the client, a Short Message Service (SMS) message received by the mobile device in real time; and
sending, by the client upon receiving a SMS message containing a particular content from a particular number, the information on the current geographical location of the mobile device to the particular number.

20. The method of claim 1, further comprising:
providing, by the server, an option for the second user to set a restricted geographical location range for the mobile device;
sending, by the client, the information on the current geographical location of the mobile device to the server; and
determining, by the server, whether the current geographical location of the mobile device is out of the restricted geographical location range.

21. The method of claim 20, further comprising:
returning, by the server upon determining that the current geographical location of the mobile device is out of the restricted geographical location range, the determination result to the client; and
parsing, by the client, the determination result returned from the server and issuing a prompt to the first user, notifying that the geographical location is out of the restricted range.

22. The method of claim 20, further comprising:
returning, by the server upon determining that the current geographical location of the mobile device is out of the restricted geographical location range, the determination result to the client; and
parsing, by the client, the determination result returned from the server and sending a prompt to a second mobile device specified by the second user.

23. The method of claim 1, further comprising:
providing, by the client, an option for the second user to select a category of website to be restricted from being browsed, a category of application to be restricted from being executed and a restricted geographical location.

24. The method of claim 3, wherein
the option comprises categories to be restricted depending on different time periods of day.

25. The method of claim 3, wherein the option provided by the client comprises a restriction rule for a particular website as set by the second user.

26. A system for applying parental control to a mobile device, comprising a client provided at the mobile device and a server provided at a server side, wherein:
the client comprises a client communication module and at least one of a website monitoring module, an application installation monitoring module and a geographical location monitoring module;
the server comprises a server communication module and at least one of a user setting module, a website analyzing module, an application analyzing module and a geographical location analyzing module;
wherein:
the client communication module is communicative with the server communication module and configured to send data to and receive data from the server;
the server communication module is communicative with the client communication module and configured to send data to and receive data from the client;
the website monitoring module is communicative with the mobile device and configured to monitor a website to be browsed by a user and submit the website to the client communication module;
the application installation monitoring module is communicative with the mobile device and configured to monitor installation of an application and submit information on the application to the client communication module;
the geographical location monitoring module is communicative with the mobile device and configured to monitor geographical location information of the mobile device in real time and submit the geographical location information to the client communication module;
the user setting module provides a communication interface and is configured to receive selection of a restriction rule by a user;
the website analyzing module is communicative with the user setting module and the server communication module and configured to determine whether to allow browsing of the website based on the restriction rule and submit the determination result to the server communication module;
the application analyzing module is communicative with the user setting module and the server communication module and configured to determine whether to allow initiation of the application based on the restriction rule and submit the determination result to the server communication module;
the geographical location analyzing module is communicative with the user setting module and the server communication module and configured to determine whether the mobile device is out of a restricted geographical range based on the restriction rule and submit the determination result to the server communication module.

27. The system of claim 26, wherein the user logs in and accesses the server via the communication interface.
